(19) United States
(12) Patent Application Publication
(10) Pub. No.: US 2007/0189843 A1
(43) Pub. Date: Aug. 16, 2007

(54) Standardized binding elements

(75) Inventors: Phillip M. Crudo, Round Lake, IL (US); Craig Simdon, Round Lake, IL (US); Jason Magid, Chicago, IL (US); Amy McManus, Chicago, IL (US); Daniel C. Jones, Gurnee, IL (US)

Correspondence Address: MICHAEL BEST & FRIEDRICH, LLP, 100 EAST WISCONSIN AVENUE, SUITE 3300, MILWAUKEE, WI, 53202, US

(73) Assignee: GENERAL BINDING CORPORATION, Northbrook, IL (US)

(21) Appl. No.: 10/531,628

(22) PCT Filed: Oct. 21, 2003
(86) PCT No.: PCT/US03/33386

§ 371 Date: Mar. 8, 2007

Related U.S. Application Data
(60) Provisional application No. 60/420,022, filed on Oct. 21, 2002.

(51) Int. Cl. B42F 13/02

(52) U.S. Cl. 402/19

(57) ABSTRACT

The invention provides a group of standardized plastic binding elements that include two, three, four, five, or seven fingers that are spaced along the spine at precise locations to accommodate the perforations spaced according to specific standardized loose-leaf hole patterns. The binding elements preferably have spines likewise corresponding to at least the length of specific standardized paper sizes, i.e., 8.27 inches (21 cm), 8.5 inches (21.5 cm) 11 inches (28 cm), 11.69 inches (30 cm), 14 inches (39.5), and 16 inches (40.5 cm). The fingers of the binding elements either secure together or to the spine when in the closed position, or the binding elements are held in the closed position by other structure such that the binding elements may be utilized to bind a stack of standard, loose-leaf sheets without the use of a binding machine. Further, the invention provides a relatively small size binding element that may be utilized to provide a relatively small bound book wherein the pages can be turned without binding.

### FIELD OF THE INVENTION

The invention relates generally to binding elements for binding a stack of sheets and more particularly to self-contained binding elements for binding stacks of sheets having standardized placement of between two and seven holes, and that do not require complex assembly machines or devices.

### BACKGROUND OF THE INVENTION

Many designs of binding elements exist for binding stacks of sheets. For example, so-called comb-binding elements, such as are shown in U.S. Pat. Nos. 1,970,285 and 2,910,068, have been utilized for decades. Comb-binding elements include a series of fingers that extend laterally for the entire length of the spine, the spine and fingers curling to form a tubular element. In use, the comb-binding element is placed on a device that uncurls the fingers so that sheets may be placed in position on the element with the ends of the fingers extending through the perforations in the paper, such as is shown in U.S. Pat. No. 4,820,099. The perforations in the paper are typically placed approximately every 0.5 inch along the edge of the paper.

So-called nail-type binding elements, such as VELOBIND® elements, are also commonly utilized in the industry. Commercial plastic nail-type elements include a male elongated rectangular spine from which nails extend approximately every 1 inch, and a female elongated spine with corresponding holes. In use, the nails are assembled in the small perforations in a stack of sheets, the openings closely mating the nails. The female spine portion is then assembled over the nails with the spines disposed along opposite sides of the stack. The binding element assembled through the edge of the stack is then inserted into a machine that cuts off the majority of the protruding ends of the nails and melts the remaining ends to form a head adjacent the female spine portion, preventing the nails from becoming disengaged from it. Books assembled with nail-type binding elements, however, cannot be readily laid flat for viewing without literally bending the pages of the book.

Twin loop type of wire binding is also utilized in the binding industry. A twin loop binding element is generally a single wire that inverts back and forth to form large loops along one lateral edge and small loops along the opposite lateral edge. The elongated element thus formed by these loops is bent to a double “C” shape, or the shape of a “3.” In use, the small loops are inserted into the rectangular perforations in the stack of sheets such that the large loops are spaced along the stack between adjacent perforations. A machine then urges the loop ends toward one another to close the two “C's” or the “3” to form a closed circle. The spaces between adjacent perforations are typically on the order of 0.25 inch.

Finally, wire or plastic coil spiral binding is commonly used in the industry. In use, a dedicated machine rotates to drive or pull either a preformed coil or a coil formed from a roll of wire adjacent the coil assembly machine into successive small openings in a stack of sheets. The coil ends are then crimped to prevent the coil from separating from the stack.

Each of these arrangements offers certain advantages. Significantly, the user can determine the entire contents of the assembled book, including the covers, as well as the internal content of the stack. Moreover, the user can often choose a desired color or appearance of the binding element, and assemble a size of binding element that is particularly suited to the size of the stack of sheets. Assembled books generally lie flat and can be readily stacked. Finally, the binding elements themselves are relatively inexpensive.

In each of these arrangements, however, a dedicated binding device is assembled into a stack of sheets with the assistance of a machine. In sharp contrast to the relatively low cost of the binding element itself, the equipment utilized to assemble books using these binding elements can be relatively expensive. As a result, the use and assembly of these binding devices is typically limited to either the office environment or dedicated copy centers, such as Kinkos, which service sufficient volume to justify the cost of the binding machine.

Further, each type of binding element requires the use of a particular, relatively dedicated perforation configuration. The user may either punch the stack of sheets prior or subsequent to printing by utilizing a punch machine configured to punch a particular perforation pattern, or the user may utilize prepunched paper in the printing process. Again, the punching machines required for these types of arrangements are not commonly available to or owned by the casual or occasional user. The actual assembly process is then performed with the assistance of the dedicated binding machine. That being the case, potential users that do not have ready access to an office environment or to commercial dedicated copy centers having such punches, are unlikely to utilize these binding arrangements for binding customized stacks of sheets.

In the United States, however, the vast majority of perforated paper is punched in a standard three-hole pattern with a centrally located hole, and holes at either side spaced 4.25 inches from the center hole. Prepunched paper may be readily purchased, and small, manual three-hole punches are readily available, in addition to the larger, commercial versions. This standardized three-hole pattern punched paper, however, cannot be readily bound by the above commercially available binders, which require particularized perforation patterns.

So-called three-ring binders, such as those marketed by Wilson-Jones, for example, have been staples of the industry for binding sheets utilizing this standardized, three-hole pattern. Such three-ring binders typically include a relatively rigid cover with front, spine, and back sides. The cover may be made of a single sheet of plastic or cardboard, or may include stiffening elements. Such three-ring binders sometimes include clear pockets along the outside of the cover to allow for the customization of the binder by the insertion of identifying cover sheets. A multi-component, metal spine from which three mechanically actuated rings protrude is secured to the inside of either the spine or back of the cover. The rings are placed at standardized locations to accommodate sheets that have been punched at standard hole patterns, i.e., the three hole pattern.

While such ring binders may be readily utilized by the casual user, they are relatively expensive. Moreover, they cannot be easily or creatively customized. Inasmuch as printing on the covers themselves generally requires the services of a professional printing arrangement, the non-professional user is typically limited to the insertion of customizing sheets or the like into pockets on the cover, where available. Three-rings binders also tend to be bulky, heavy, and all but render stacking of assembled books prohibitive. In Europe, two- and four-hole patterns are the standardized format as opposed to the three-hole pattern in the United States.

Moreover, standard ring binders are not particularly suited for books of relatively small thicknesses, such as those including stacks of sheets on the order of ½ inch thick or less. In order to permit the turning of the perforated pages, i.e., in order to prevent interference and binding at the back gauge of the perforated sheets, as well as for fabrication purposes, the rings must be relatively large as compared to the stack itself, resulting in a considerable taper in the thickness of the bound book from one side to the other and a large ring extending from the edge of the stack of sheets at the spine. While other specialized binding elements, such as comb binding, spiral coils, or twin loop binding elements typically include smaller thickness elements and, therefore, can result in books with a smaller bound edge, these binding elements commonly exhibit similar interference and binding at the back gauge of the perforated sheets. Alternately, to facilitate unobstructed turning of pages, a relatively larger coil, twin loop, or comb binding element must be selected, again resulting in a relatively large binding element at the edge of the stack due to the complete annular cross-section of these devices.

### OBJECTS OF THE INVENTION

It is an object of the invention to provide a plurality of binding elements that may be utilized with the standard perforation patterns for sheets to provide a professionally bound appearance. A more specific object is to provide such binding elements that may be assembled into and secured in a closed position without the use of machinery such that the binding elements may be utilized without the necessity of commercial or professional binding facilities.

An additional object of the invention is to provide a binding element which may be economically and efficiently manufactured.

A further object is to provide a binding element which may be molded using conventional molding techniques.

### BRIEF SUMMARY OF THE INVENTION

The invention provides a group of standardized plastic binding elements that include two, three, four, five, or seven fingers that are spaced along the spine at precise locations to accommodate the perforations spaced according to specific standardized loose-leaf hole patterns. The binding elements preferably have spines likewise corresponding to at least the length of specific standardized paper sizes, i.e., 8.27 inches, 8.5 inches, 11 inches, 11.69 inches, 14 inches, and 16 inches. The fingers of the binding elements either secure together or to the spine when in the closed position, or the binding elements are held in the closed position by other structure such that the binding elements may be utilized to bind a stack of standard, loose-leaf sheets without the use of a binding machine. Further, the invention provides a relatively small size binding element that may be utilized to provide a relatively small bound book wherein the pages can be turned without binding.

These and other objects and advantages of the invention will be apparent to those skilled in the art upon reading the following summary and detailed description and upon reference to the drawings.

### BRIEF DESCRIPTION OF THE DRAWINGS

FIG. 1 is a perspective view of a first embodiment of a binding element constructed according to teachings of the invention.

FIG. 2 is an elevational view of an end of the binding element of FIG. 1.

FIG. 3 is an elevational view of the opposite end of the binding element of FIG. 1.

FIG. 4 is a right side elevational view of the binding element of FIG. 1.

FIG. 5 is a bottom view of the binding element of FIG. 1.

FIG. 6 is a left side elevational view of the binding element of FIG. 1.

FIG. 7 is a top plan view of the binding element of FIG. 1.

FIG. 8 is a perspective view of a second embodiment of a binding element constructed according to teachings of the invention.

FIG. 9 is an elevational view of an end of the binding element of FIG. 8.

FIG. 10 is an elevational view of the opposite end of the binding element of FIG. 8.

FIG. 11 is a right side elevational view of the binding element of FIG. 8.

FIG. 12 is a bottom view of the binding element of FIG. 8.

FIG. 13 is a left side elevational view of the binding element of FIG. 8.

FIG. 14 is a top plan view of the binding element of FIG. 8.

FIG. 15 is a perspective view of a third embodiment of a binding element constructed according to teachings of the invention.

FIG. 16 is a perspective view of a fourth embodiment of a binding element constructed according to teachings of the invention.

FIG. 17 is a perspective view of a fifth embodiment of a binding element constructed according to teachings of the invention.

FIG. 18 is an enlarged cross-sectional view of the binding elements of FIGS. 1-17 taken along line 18-18 in FIG. 17.

FIG. 19 is a diagram of various loose-leaf perforation patterns commonly utilized in the United States and internationally.

### BRIEF DESCRIPTION OF THE REPRESENTATIVE EMBODIMENTS

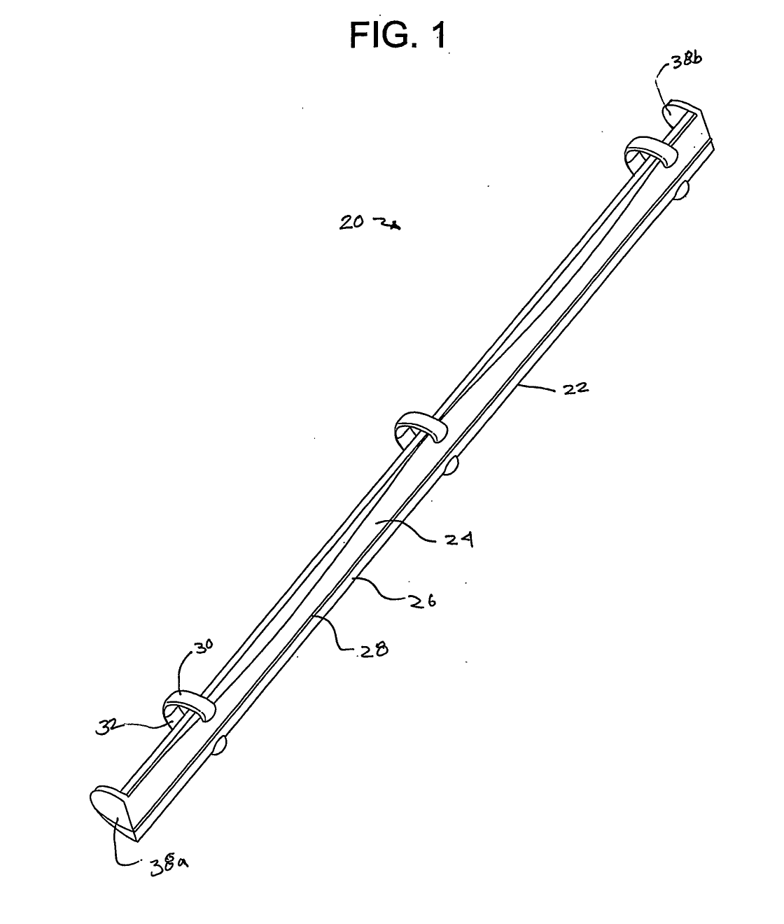

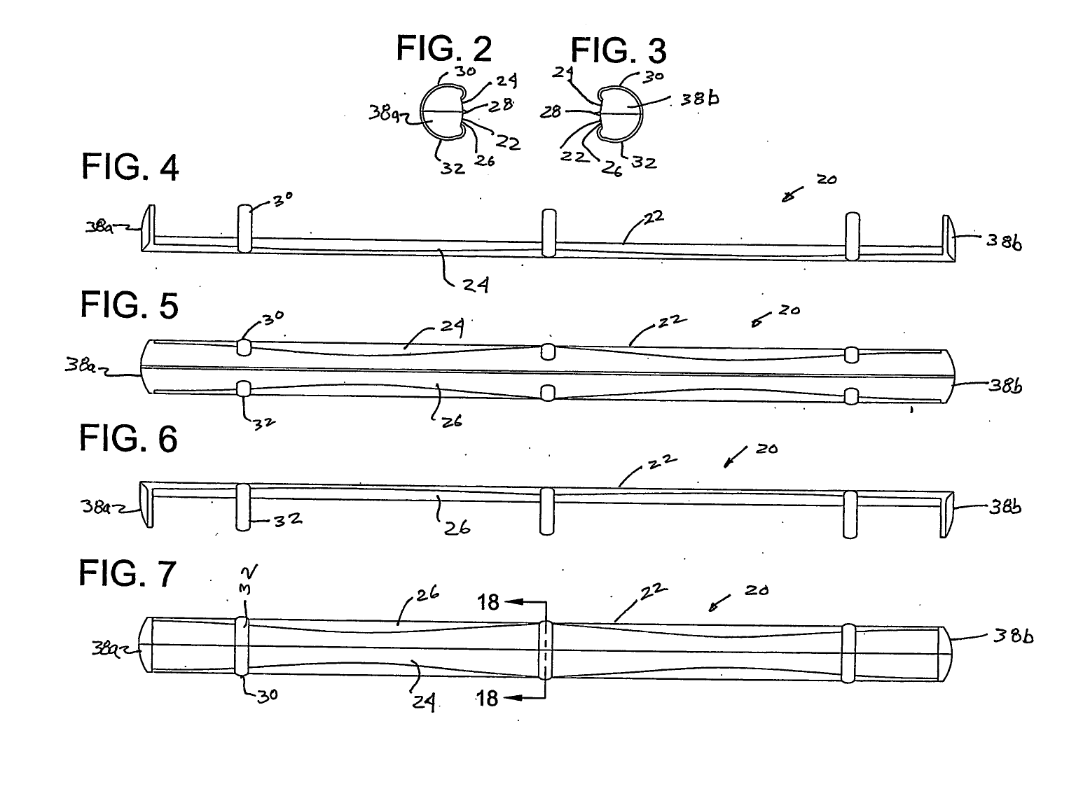

Turning now to the drawings, there are shown in FIGS. 1-7 various views of a binding element 20 constructed in accordance with teachings of the invention. The binding element 20 includes an elongated spine 22, having two elongated sections 24, 26 with a living hinge 28 therebetween. Pairs of fingers 30, 32 extend from the elongated side sections 24, 26, respectively, for insertion into the perforations of a stack of sheets (not shown). The elongated sections 24, 26 pivot relative to one another along the hinge 28 to move the binding element 20 between the open position for receiving a stack of sheets and the closed position (as shown) for retaining a stack of sheets, the fingers 30,32 forming closed loops when the binding element is in its closed position, as shown.

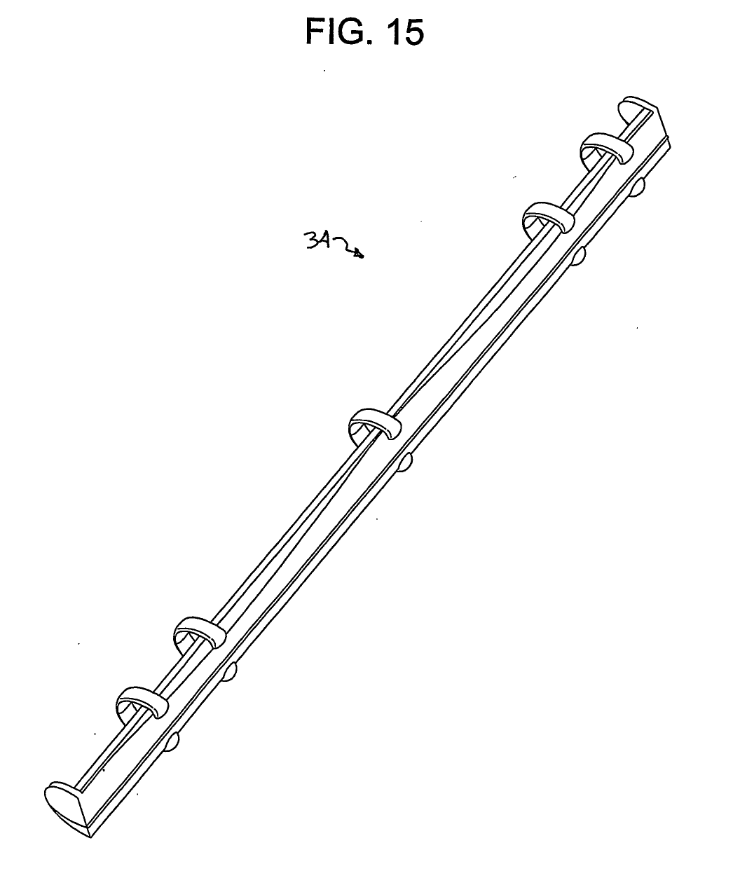

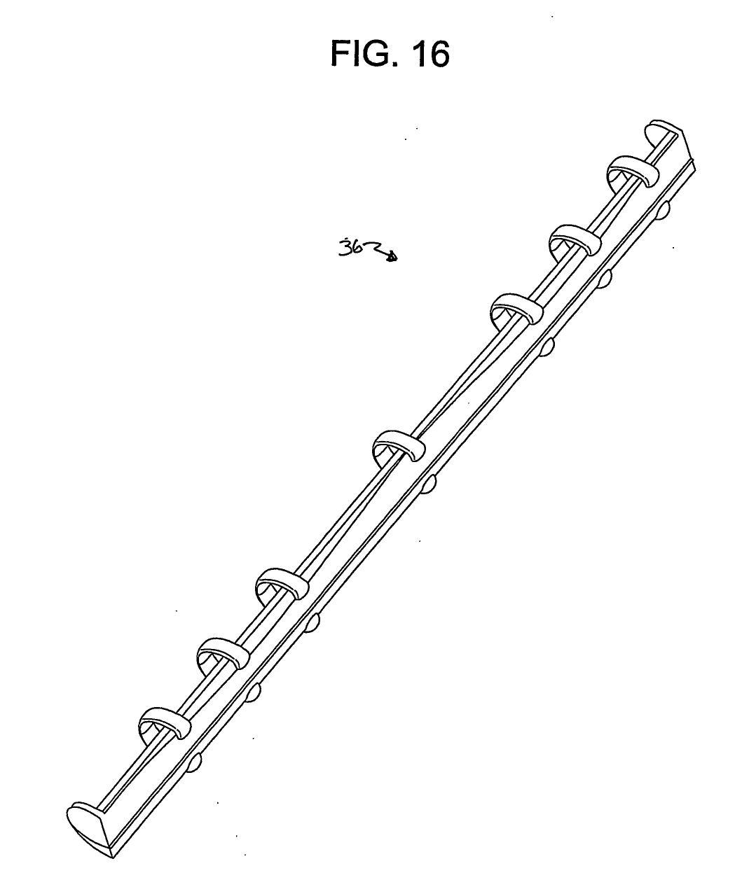

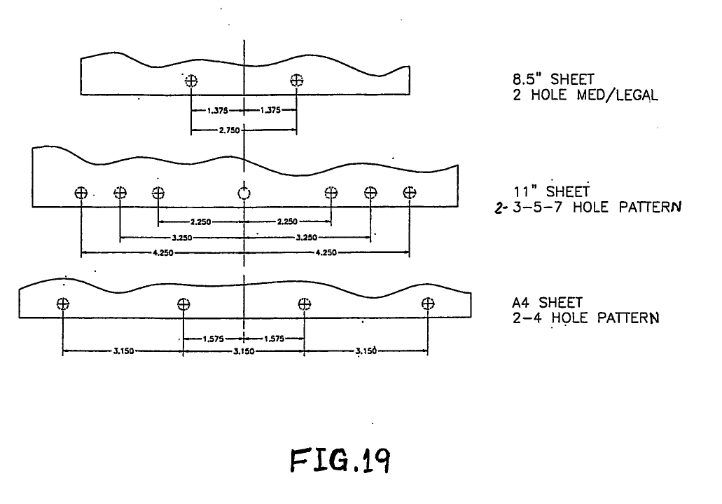

In accordance with the invention, the binding element 20 is arranged for use with sheets including standard sizes of loose-leaf perforation patterns, examples of which are graphically illustrated in FIG. 19. The following dimensions are provided only as estimations of the standardized proportions inasmuch as the exact dimensions may vary as a result of processes and manufacturing parameters and variations. More particularly, a three-hole punch pattern is commonly utilized in the United States along the edge of 11 inches sheets, with the holes typically placed on center, and at 4.25 inches on either size of center, or only two holes at 4.25 inches on either side of center. When the number of holes is increased to five in the standard size punching pattern in the United States, an additional pair of holes is placed at 3.25 inches on either side of center, and when increased to seven-hole, an additional pair is placed at 2.25 inches on either side of center. Accordingly, the binding element 20 according to the preferred design includes a spine 22 on the order of 11 inches to long and having three pairs of fingers 30, 32, as shown in FIGS. 1-7, the center pair of fingers being placed on center, and the outer fingers being placed at 4.25 inches on either side of center. In this way, the fingers 30, 32 of the binding element 20 are received in the perforations of three-hole, five-hole, or seven-hole paper to bind the stack into a book with a single binding element. It will be appreciated, however that binding elements 34, 36 having five or seven fingers may alternately be provided, such as are shown in FIGS. 15 and 16.

In order to provide an even more polished appearance to the bound book, the binding element 20 may additionally include end tabs 38a, 38b, as may be seen in FIGS. 1-7, for example. It will further be appreciated that these tabs 38a, 38b will help to minimize opportunity for the corners of sheets adjacent the binding element 20 to become ruffled or bent.

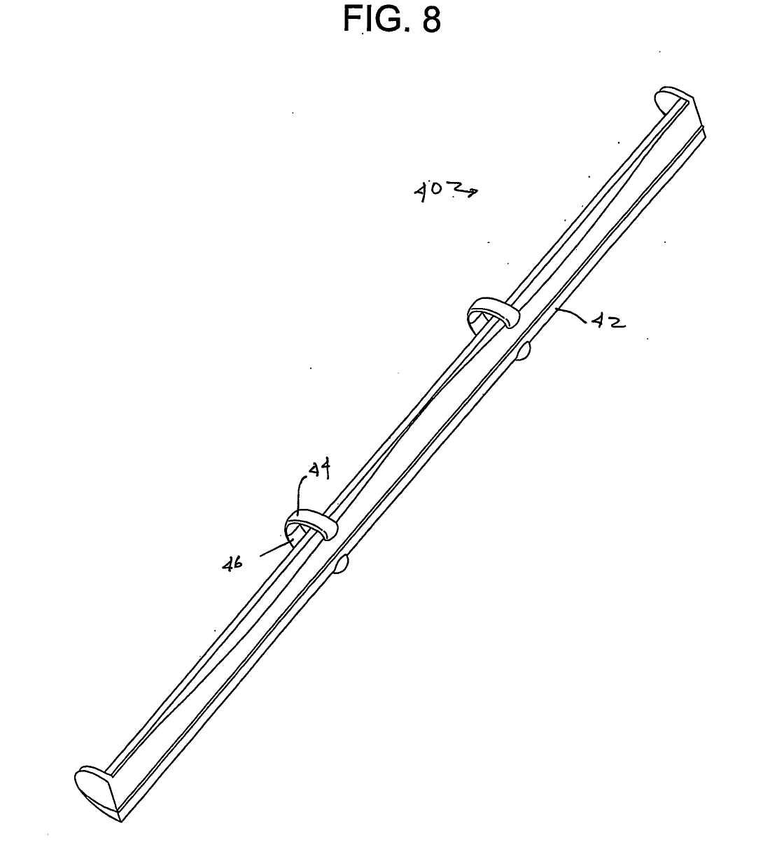

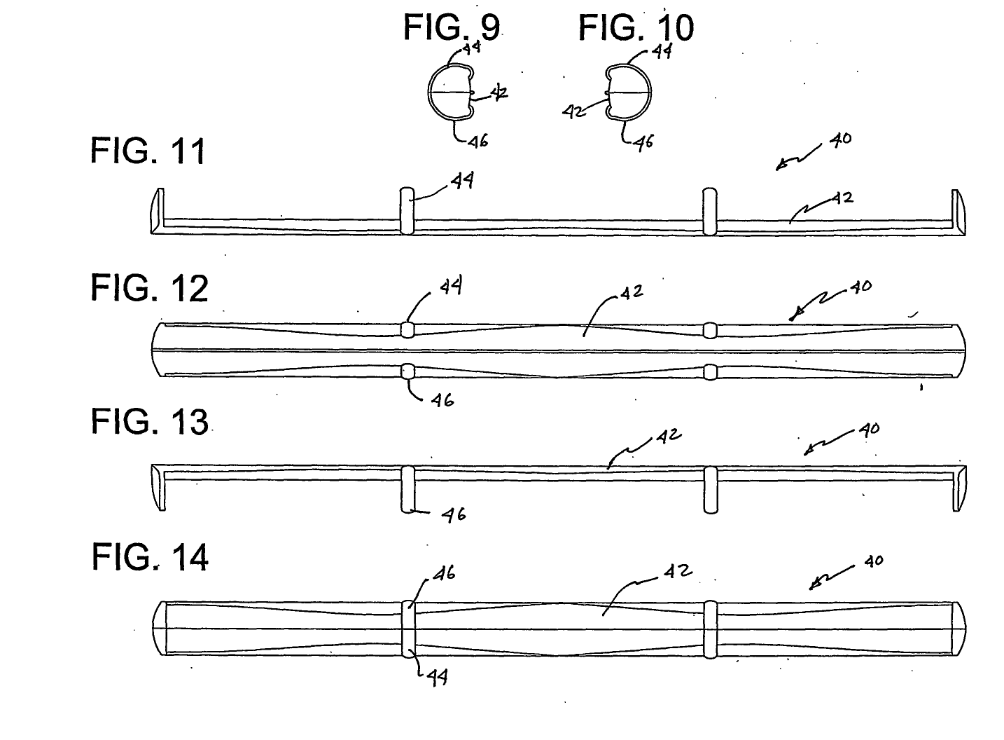

An alternate pattern sometimes utilized is a two-hole pattern, typically along the short edge, or the 8.5 inches edge of sheets. In this arrangement, the holes are placed 2.75 inches apart, or 1.375 inches on either side of center, as likewise shown in FIG. 19. Thus, according to teachings of the invention, there is also provided a binding element 40 having a spine 42 on the order of 8.50 inches long and having two pairs of fingers 44, 46 placed 2.75 inches apart, preferably 1.375 inches on either side of center, as shown, for example, in FIGS. 8-14.

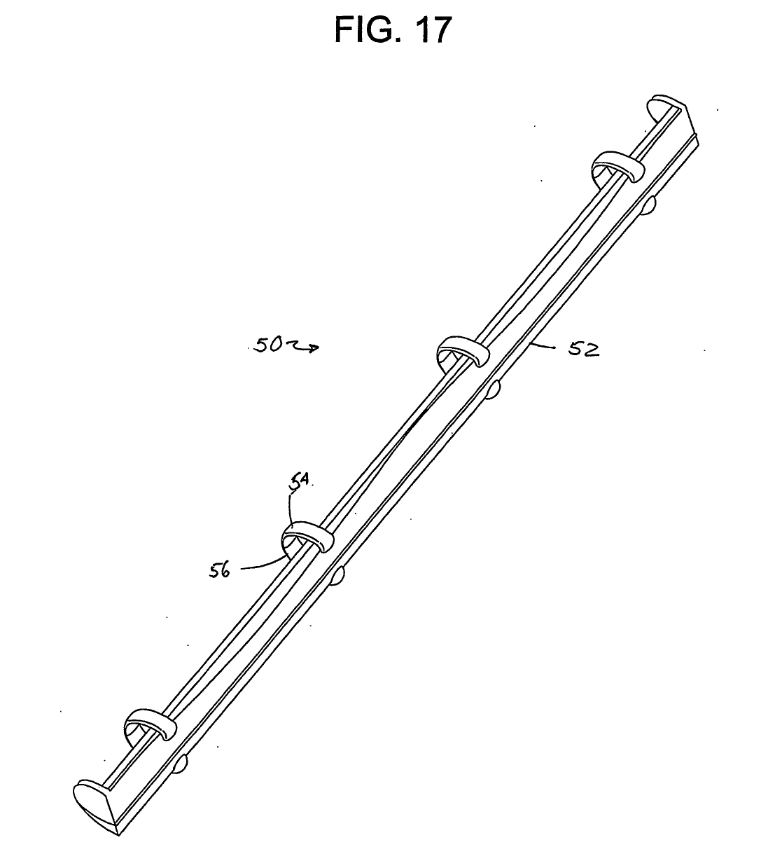

In contrast to the three-hole pattern commonly utilized in the United States, many foreign countries, including those Europe typically utilize two or sometimes four holes per sheet edge. More specifically, as shown in FIG. 19, in such a two-hole pattern, perforations are placed 3.15 inches apart, preferably about center, i.e., at 1.575 inches on either side of center. With the four-hole pattern, a pair of perforations is provided 3.15 inches from the first perforations, i.e., 3.15 inches from each of the perforations on either side of center. Accordingly, in other preferred design binding elements 40, 50, two or four fingers 44, 46, 54, 56 are provided along a spine 42, 52, as shown in FIGS. 8-14 and FIG. 17, respectively, the fingers being distributed 3.15 inches apart, preferably about center. Inasmuch as the paper typically utilized in Europe is A4, or 8.27 inches by 11.69 inches, the spine is preferably on the order of 8.27 or 11.69 inches long.

According to other important features of the invention, the binding element 20, 34, 36, 40, 50 is both economical for the user to purchase and economical for the user to install. That being the case, the binding element 20, 34, 36, 40, 50 is preferably formed of a plastic material and may be fabricated by injection molding or the like. Further, the binding element 20, 34, 36, 40, 50 may be inserted into the stack of sheets and closed without the assistance of a binding machine. In this regard, the binding element 20, 34, 36, 40, 50 may be secured with the closed position by any appropriate structure, either permanently or releasably. In the currently preferred embodiment of the invention, the ends 34, 36 of the fingers 30, 32 include mating structure for holding the binding elements 20 in a closed position. The mating structure may be any of the arrangements shown in U.S. Pat. No. 6,270,280, for example, which is likewise assigned to the assignee of this application, and in which the ends include button-like structures, hooks, or other protrusions, so long as no machine is required in order to actually perform the binding function. Similar or varied securing structure may be provided along the spine or the end tabs, or external structures may be provided. Alternately, the binding element may be secure in a closed position by a biasing structure, such as, for example, structures which are stretched or moved over-center upon opening the binding element, and then return to the original shape or length upon closing the binding element.

It will be appreciated by those of skill in the art, that, while the inventions has been described with regard to certain standard hole patterns in connection with certain paper sizes, these standard hole patterns might likewise be provided with regard to other standard sizes of sheets. For example, the two-finger arrangement of FIGS. 8-14 might likewise be utilized with a spine that is 11 inches long in order to accommodate a two-hole pattern applied to an 11 inch side of a sheet. It will further be appreciated that while the invention has been described with regard to pairs of fingers portions that extend from hingedly connected elongated side sections of a spine, there might alternately be single finger loops the free ends of which couple directly to the spine to close the binding element, rather than the free ends of the pairs of finger portions coupling to one another.

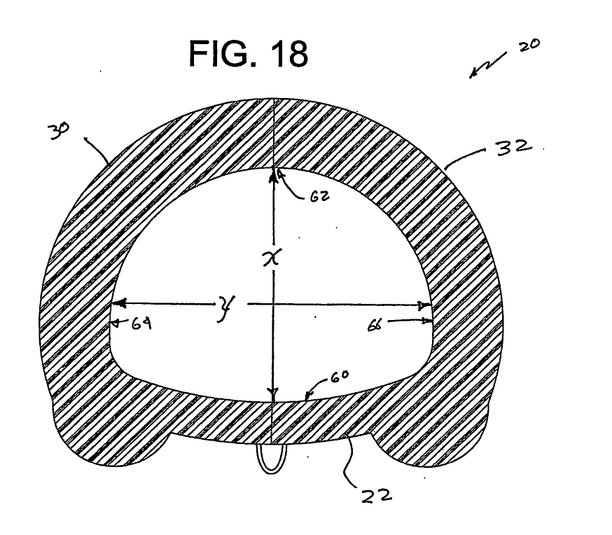

Finally, according to another feature of the invention, the binding element 20 may be of a relatively small size in order to effectively bind relatively small stacks of sheets while presenting a bound book with an attractive appearance. In order to minimize the size of the binding element 20 required to bind the stack, the profile (see FIG. 18) of the spine 22 and fingers 30, 32 is provides sufficient clearance for turning the successive sheets of the book, while minimizing any unnecessary clearance. More specifically, the binding element 20 provides sufficient clearance to allow the pages to lie flat, but minimizes the space required for turning the sheets.

When holes are punched in a sheet, the paper remaining between the holes themselves and the edge of the sheet is generally referred to as the “back gauge.” In standard punching configurations, the back gauge is typically on the order of 0.225 inch. In accordance with the invention, the binding element profile has a “D” shaped configuration, the minor diameter, distance x between the inside surface 60 of the spine 22 and the opposite, inside surface 62 of the fingers 30, 32 is less than the major diameter, distance y between the inside surfaces 64, 66 of the fingers 30, 32, at opposite, lateral sides of the binding element. More specifically, it has been determined that, for a back gauge of 0.225 inch, the distance x must be a minimum of 0.375 inch, while the distance y at just over 0.225 inch below the inside surface 62 of the fingers 30, 32 must be a minimum of 0.5 inch in order to obtain successive, smoothly turning pages. It will be appreciated by those of skill in the art that should the back gauge be increased, the relative distances x and y would likewise need to be increased accordingly.

In summary, the invention provides a group of standardized plastic binding elements that include two, three, four, five, or seven fingers that are spaced along the spine to accommodate the perforations spaced according to specific standardized loose-leaf hole patterns. The binding elements preferably have spines likewise corresponding to at least the length of specific standardized paper sizes, i.e., 8.27 inches, 8.5 inches, 11 inches, 11.69 inches, 14 inches, and 16 inches. The fingers of the binding elements either secure together or to the spine when in the closed position, or the binding elements are held in the closed position by other structure such that the binding elements may be utilized to bind a stack of standard, loose-leaf sheets without the use of a binding machine. Moreover, the invention provides a relatively small size binding element that may be utilized to provide a relatively small bound book wherein the pages can be turned without binding.

While this invention has been described with an emphasis upon preferred embodiments, variations of the preferred embodiments can be used, and it is intended that the invention can be practiced otherwise than as specifically described herein. Accordingly, this invention includes all modifications encompassed within the spirit and scope of the invention as defined by the following claims.

All of the references cited herein, including patents, patent applications, and publications, are hereby incorporated in their entireties by reference.

We claim as our invention:

1. A binding element for use in binding stacks of sheets having openings spaced at standard distances from one another, the sheets defining a back gauge between the openings and an edge of the sheets, the binding element comprising:
an elongated spine
at least two and no more than seven fingers forming closed loops with the spine, said fingers being adapted for movement between an open position for receiving said stack of sheets and a closed position for maintaining said stack of sheets, said fingers being spaced at said standard distances for receipt into said openings, and
structure for maintaining said fingers in said closed position.

2. The binding element of claim 1 wherein the spine and fingers are unitarily formed of a polymeric material.

3. The binding element of claim 1 wherein each said finger has a central axis, said binding element comprising two fingers having central axes spaced apart on the order of 2.75 inches (7 cm).

4. The binding element of claim 1 wherein each said finger has a central axis, said binding element comprising two fingers having central axes spaced apart on the order of 8.5 inches (21.5 cm).

5. The binding element of claim 1 comprising first, second and third fingers wherein each said finger has a central axis, said first, second and third fingers being linearly disposed, said first and second fingers having central axes spaced apart on the order of 4.25 inches (11 cm), and said second and third fingers having central axes spaced apart on the order of 4.25 inches (11 cm).

6. The binding element of claim 1 wherein each said finger has a central axis, said binding element comprising two fingers having central axes spaced apart on the order of 3.15 inches (8 cm).

7. The binding element of claim 1 comprising first, second, third, and fourth fingers wherein each said finger has a central axis, said four first, second, third and fourth fingers linearly disposed, said first and second fingers having central axes spaced apart on the order of 3.15 inches (8 cm) said second and third fingers having central axes spaced apart on the order of 3.15 inches (8 cm), and said third and fourth fingers having central axes spaced apart on the order of 3.15 inches (8 cm).

8. The binding element of claim 1 wherein each said finger has a central axis, said binding element comprising two fingers having central axes spaced apart on the order of 6.3 inches (16 cm).

9. The binding element of claim 1 wherein each said finger has a central axis, said binding element comprising five fingers linearly disposed including a central finger, a pair of outermost fingers, and a pair of intermediate fingers disposed between the central and outermost fingers, the outermost fingers having central axes spaced on the order of 4.25 inches (11 cm) from the central axis of the central finger, and the intermediate fingers having central axes spaced on the order of 3.25 inches (8.5 cm) from the central axis.

10. The binding element of claim 1 wherein each said finger has a central axis, said binding element comprising seven fingers linearly disposed including a central finger, a pair of outermost fingers, a first pair of intermediate fingers disposed between the central and outermost fingers, and a second pair of intermediate fingers disposed between the central and the first pair of intermediate fingers, the outermost fingers having central axes spaced on the order of 4.25 inches (11 cm) from the central axis of the central finger, the first set of intermediate fingers having central axes spaced on the order of 3.25 inches (8.5 cm) from the central axis, and the second set of intermediate fingers having central axes spaced on the order of 2.25 inches (5.5 cm) from the central axis.

11. The binding element of any of claim 1 wherein the fingers form a closed loop with the spine, the closed loop having a generally oval shape having a major diameter and a minor diameter, the major diameter is at least 0.05 inch greater than twice the back gauge, and the minor diameter is at least 0.10 inch greater than the back gauge.

12. The binding element of any of claim 1 wherein the fingers form a closed loop with the spine, the closed loop having a generally “D” shape having a major diameter and a minor diameter, the major diameter is at least 0.03 greater than twice the back gauge, and the minor diameter is at least 0.10 inch greater than the back gauge, the minor diameter being disposed between the spine and the fingers.

13. The binding element of claim 11 wherein the major diameter is no more than 0.50 inch greater than twice the back gauge, and the minor diameter is no more than 0.20 inch greater than the back gauge.

14. The binding element of claim 11 the major diameter and a minor diameter, the major diameter being on the order of 0.05 inch greater than twice the back gauge, and the minor diameter being on the order of 0.15 inch greater than the back gauge.

15. The binding element of any of claim 1 further comprising structure to secure the fingers in said closed position.

16. The binding element of claim 15 wherein the spine and at least one said finger comprises mating structure, and the structure to secure comprises said mating structure.

17. The binding element of claim 15 wherein each finger comprises a pair of finger elements and at least one said pair of finger elements has mating structure at its distal ends, and the structure to secure comprises the mating structure.

18. The binding element of claim 15 wherein the spine comprises at least a pair of elongated spine elements, and the structure to secure comprises a coupling structure along the spine elements.

19. The binding element of claim 15 further comprising end tab portions, said structure to secure comprising a coupling structure along the end tab portions.

20. The binding element of claim 15 wherein the structure to secure comprises a biasing structure that biases the fingers in a closed position.

21. The binding element of any of claim 15 wherein the structure to secure substantially permanently secures the fingers in a closed position.

22. The binding element of any of claim 15 wherein the structure to secure releasably secures the fingers in a closed position.

23. The binding element of any of claim 1 wherein the spine comprises at least two hingedly coupled, elongated spine elements.

24. The binding element of any of claim 1 wherein each finger comprise a pair of finger elements extending from the elongated spine elements respectively.

25. The binding element of any of claim 1 wherein the spine has a length on the order of 8-16.5 inches (20-42 cm).

26. The binding element of claim 25 wherein the spine has a length on the order of 8.3 inches (21 cm), 8.5 inches (21.5 cm), 11 inches (28 cm), 11.7 inches (30 cm), 14 inches (35.5 cm), or 16 inches (40.5 cm).

27. (canceled)
